(19) United States
(12) Patent Application Publication
(10) Pub. No.: US 2008/0067145 A1
(43) Pub. Date: Mar. 20, 2008

(54) METHOD OF RECYCLING DUMMY WAFER

(75) Inventors: Chih-Chun Wang, Tainan County (TW); Chia-Pin Lee, Hsinchu City (TW); Chun-Yuan Wu, Yunlin County (TW); Hsien-Che Teng, Tainan City (TW); Hsin-Hsing Chen, Pingtung County (TW); Yu-Cheng Lin, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: UNITED MICROELECTRONICS CORP., Hsinchu (TW)

(21) Appl. No.: 11/532,088

(22) Filed: Sep. 14, 2006

(51) Int. Cl. C03C 15/00; C03C 25/68

(52) U.S. Cl. 216/57; 216/83; 216/58; 216/74; 216/96

(57) ABSTRACT

A method of recycling dummy wafer is provided. The dummy wafer has at least one low-k dielectric material layer formed thereon. A treatment process is performed to the low-k dielectric material layer on the dummy wafer so that a component or impurity in the low-k dielectric material layer reacts to form a volatile substance. A wet etching process is performed to remove the low-k dielectric material layer.

### BACKGROUND OF THE INVENTION

1. Field of the Invention

The present invention relates to a recycling method, and more particularly, to a method of recycling dummy wafer in a semiconductor process.

2. Description of Related Art

After the development of integrated circuits with deep sub-micron dimension, low-k dielectric constant material with a dielectric constant below 5 is deployed to form the dielectric layer or the barrier layer between multi-layered metallic interconnects so that parasitic capacitance between the metallic layers is reduced and RC delay is minimized. Thus, the device can have a better operating characteristic.

Low-k dielectric constant material may be classified into two major types, organic low-k dielectric constant material and inorganic low-k dielectric material. A low-k dielectric constant material layer is formed either by performing a spin-coating process or a deposition process. In general, before carrying out the actual deposition process for producing low-k dielectric constant material products using a machine, the machine must be checked and the conditions of the machine must be monitored to ensure a high production quality and processing stability. The machine is usually checked on a daily basis using a dummy wafer, which is a blank wafer with a low-k dielectric material deposited thereon. Properties such as the particle size, uniformity of thickness and reflectivity of the low-k dielectric constant layer on the dummy wafer are measured to determine the actual working conditions of the machine.

After obtaining all relevant information about the machine, a wet etching process is performed to remove the low-k dielectric material layer on the dummy wafer so that the dummy wafer can be recycled to save cost. However, if the low-k dielectric constant material is a material containing carbon such as SiC, SiCN, SiCO, SiCOH, or SiCNO or is a porous material capable of adsorbing carbon impurities, the dummy wafer may have to be scrapped because carbon-containing material cannot be completely removed in a wet etching process. Because the dummy wafer having carbon-containing low-k dielectric constant material layer cannot be recycled, a new dummy wafer has to be used for checking the machine. Hence, the production cost is needlessly increased.

### SUMMARY OF THE INVENTION

Accordingly, the present invention is to provide a method of recycling dummy wafer that can easily and effectively remove any carbon-containing low-k dielectric constant material on a dummy wafer.

The present invention is to provide a method of recycling dummy wafer that can easily and effectively remove any porous material with adsorbed impurities on a dummy wafer.

To achieve these and other advantages and in accordance with the purpose of the invention, as embodied and broadly described herein, the invention provides a method of recycling dummy wafer. The dummy wafer has at least one low-k dielectric material layer formed thereon and the low-k dielectric constant material layer contains a component or an adsorbed impurity difficult to be removed by a wet etching process. The recycling method includes performing a treatment process to the low-k dielectric material layer on the dummy wafer so that the component or impurity in the low-k dielectric material layer reacts to form a volatile substance. Then, a wet etching process is performed to remove the low-k dielectric material layer.

According to one embodiment of the present invention, the aforementioned component or impurity includes carbon. The material constituting the aforementioned low-k dielectric constant material layer includes SiC, SiCN, SiCO, SiCOH, SiCNO or porous substance.

According to one embodiment of the present invention, the treatment process includes performing an oxidation and/or a fluorination process.

According to one embodiment of the present invention, the treatment process includes performing a thermal oxidation process, a plasma oxidation process or a dry etching process. The thermal oxidation process uses an oxidizing agent selected from a group consisting of oxygen, nitrous oxide, carbon dioxide, ozone and combination thereof and performed at a temperature between about 200° C. to 1500° C. The gas for performing the plasma oxidation process is selected from a group consisting of oxygen, carbon dioxide, nitrous oxide and combination thereof. The reactive gas for performing the dry etching process includes fluorine-containing gas and oxygen such as carbon tetrafluoride and/or nitrogen trifluoride.

According to one embodiment of the present invention, in the beginning or during the plasma oxidation process or dry etching process, further includes pin up the dummy wafer via the back surface of the substrate. Hence, the bevel area at the back of the substrate is exposed so that the low-k dielectric constant material layer covering the bevel area at the back of the substrate can also be removed.

According to one embodiment of the present invention, the wet etching process is performed using an etching agent that contains hydrofluoric acid.

According to one embodiment of the present invention, the low-k dielectric constant material layer includes a dielectric layer and/or a barrier layer.

The present invention also provides a method of removing a low-k dielectric constant material layer on the bevel area at the back of a substrate. The low-k dielectric constant material layer contains a component or an impurity difficult to be removed by a wet etching process. The method includes pin up the substrate via the back of the substrate to expose the low-k dielectric constant material layer covering the bevel area at back of the substrate. Then, a treatment process to the low-k dielectric material layer is performed so that the component or impurity in the low-k dielectric material layer reacts to form a volatile substance. Finally, a wet etching process is performed to remove the low-k dielectric material layer.

According to one embodiment of the present invention, the aforementioned component or impurity includes carbon. The material constituting the aforementioned low-k dielectric constant material layer includes SiC, SiCN, SiCO, SiCOH, SiCNO or porous substance.

According to one embodiment of the present invention, the treatment process includes performing an oxidation and/or a fluorination process.

According to one embodiment of the present invention, the treatment process includes performing a plasma oxidation process or a dry etching process. The gas for performing the plasma oxidation process is selected from a group consisting of oxygen, carbon dioxide, nitrous oxide and combination thereof. The reactive gas for performing the dry etching process includes oxygen and a fluorine-containing gas such as carbon tetrafluoride and/or nitrogen trifluoride.

According to one embodiment of the present invention, the wet etching process is performed using an etching agent that contains hydrofluoric acid.

According to one embodiment of the present invention, the low-k dielectric constant material layer includes a dielectric layer and/or a barrier layer.

The method of recycling dummy wafer in the present invention includes performing a treatment process to the low-k dielectric constant material layer so that any component and impurity in the low-k dielectric constant material difficult to be removed by a wet etching process is turned into a volatile substance. Thus, the residual low-k dielectric constant material layer can be easily and completely removed by a wet etching process.

Furthermore, by pin up the substrate via the back of the substrate in the present invention, the low-k dielectric constant material layer covering the bevel area at the back of the substrate is exposed. Therefore, after performing the treatment process and the wet etching process, the low-k dielectric constant material layer covering the bevel area at the back of the substrate is easily and completely removed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1C are schematic cross-sectional views showing a method of recycling dummy wafer according to one embodiment of the present invention.

FIG. 2 is a flow diagram showing the steps in a method of recycling dummy wafer according to one embodiment of the present invention.

FIG. 3 is a schematic cross-sectional view of a semiconductor device in one embodiment of the present invention.

FIG. 4 is a schematic cross-sectional view showing a dummy wafer pined up to expose the back of the dummy wafer according to one embodiment of the present invention.

FIG. 5 is a photo showing a method of recycling a dummy wafer by performing a high temperature oxidation process according to one embodiment of the present invention.

FIG. 6A is a photo showing a method of recycling a dummy wafer by performing a direct treatment process with hydrofluoric acid.

FIG. 6B is a photo showing a method of recycling a dummy wafer by performing an etching process using carbon tetrafluoride (CF₄) and oxygen (O₂) as the reactive gases and performing an etching process with hydrofluoric acid thereafter.

FIG. 6C is a photo showing a method of recycling a dummy wafer by pin up the dummy wafer, performing an etching process using carbon tetrafluoride (CF₄) and oxygen (O₂) as the reactive gases and performing an etching process with hydrofluoric acid thereafter.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The method in the present invention is suitable for recycling a dummy wafer with at least one low-k dielectric constant material layer thereon. The method includes performing a treatment process to the low-k dielectric constant material layer so that a difficult-to-remove component or impurity in the low-k dielectric constant material layer reacts to form a volatile substance. After that, a wet etching process is performed to remove the low-k dielectric constant material layer.

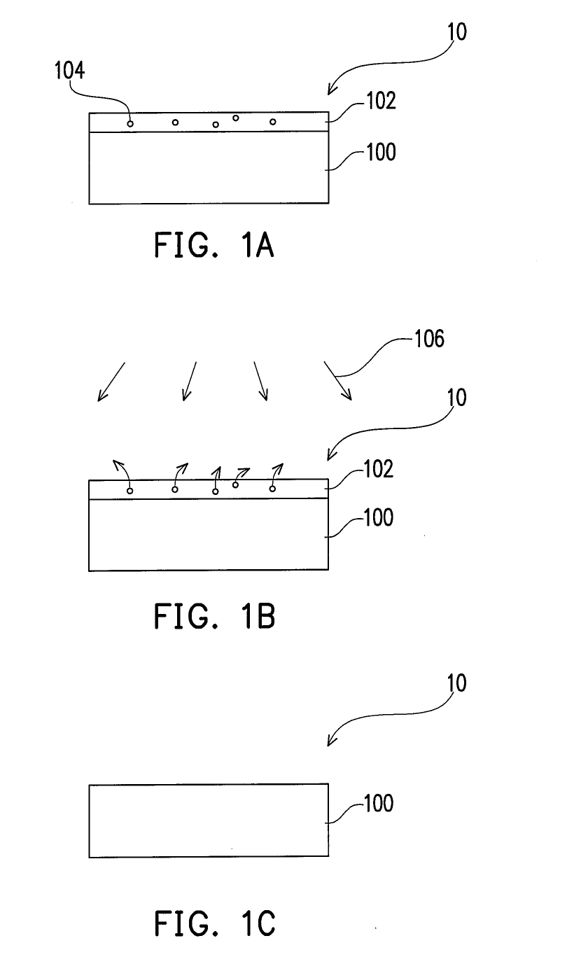

In the following, FIGS. 1A through 1C, FIG. 2, FIG. 3 and FIG. 4 are used to explain the application of the present invention. However, the following description should by no means be used to limit the scope of the present invention.

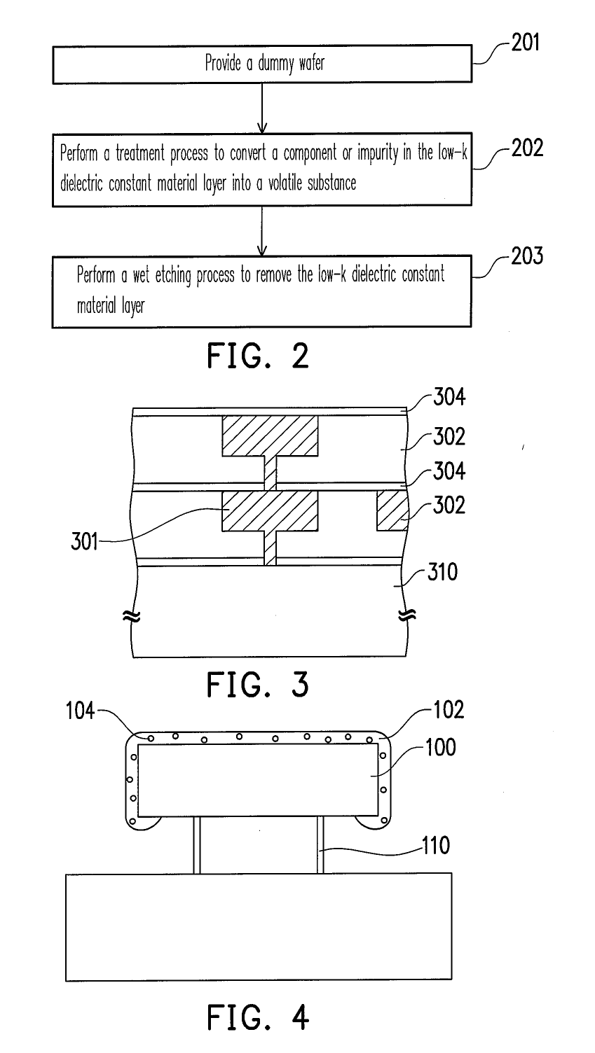

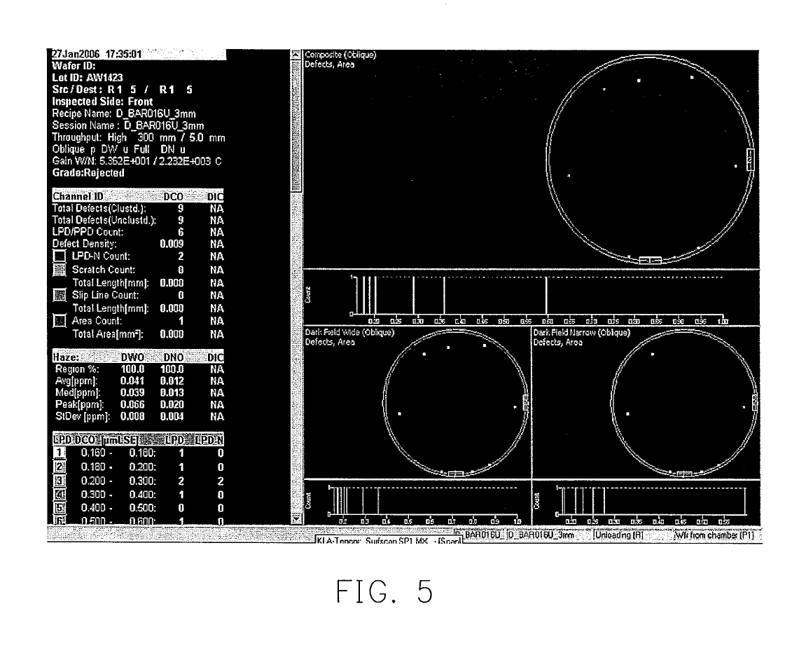

As shown in FIGS. 1A and 2, a dummy wafer 10 is provided in step 201. The dummy wafer 10 is used as a wafer for testing machine depositing of low-k dielectric constant material. The dummy wafer 10 includes a substrate 100 having a low-k dielectric constant material layer 102 with a dielectric constant below 5 formed thereon. In one embodiment, the low-k dielectric constant material layer on the dummy wafer 10 serves as a dielectric layer 302 for isolating a metallic layer 301 in a semiconductor substrate 300 as shown in FIG. 3. Through this dummy wafer 10, the operating conditions of the depositing machine are checked. In another embodiment, the low-k dielectric constant material layer on the dummy wafer 10 is used as a barrier layer 304 of the semiconductor substrate 300 as shown in FIG. 3. Through this dummy wafer 10, the operating conditions of the depositing machine are checked.

As shown in FIGS. 1A and 2, the low-k dielectric constant material layer 102 has a component 104, such as carbon, that is difficult to remove in a conventional wet etching process using hydrofluoric acid as the etchant. The carbon component is, for example, silicon carbide (SiC), silicon carbonitride (SiCN), silicon-oxycarbide (SiCO), carbon-doped silicon oxide (SiCOH) or silicon oxycarbonitride (SiCNO). The low-k dielectric material layer 102 can also be a porous material layer. Due to the porosity of the porous material layer, impurity 104 such as carbon is easily adsorbed. The adsorbed impurity 104 is difficult to remove in a wet etching process using, for example, hydrofluoric acid as the etchant. When the low-k dielectric constant material layer 102 serves as a dielectric layer in a semiconductor process, the material constituting the dielectric layer includes, for example, SiC, SiCN, SiCO, SiCOH or porous material. On the other hand, when the low-k dielectric constant material layer 102 serves as a barrier layer in a semiconductor process, the material constituting the barrier layer includes, for example, SiCNO.

As shown in FIGS. 1B and 3, a process treatment is performed in step 106 so that the difficult-to-remove component or impurity in the low-k dielectric constant material layer 102 can react to form a volatile substance 108. In one embodiment, the process treatment 106 can be an oxidation process that utilizes the easy reaction of oxygen with carbon to produce a volatile substance such as carbon dioxide. In another embodiment, the treatment process can be a fluorination process that utilizes the easy reaction of fluorine with carbon to produce a volatile substance such as fluorocarbon compound. In yet another embodiment, the treatment process can be an oxidation process and a fluorination process that forms volatile substances such as carbon dioxide and fluorocarbon compound. In addition, the treatment process 106 can be a thermal oxidation process, a plasma oxidation process or a dry etching process. The thermal oxidation process is carried out in a furnace or a heating chamber using an oxidizing agent so that the component or impurities in the low-k dielectric constant material layer 102 is oxidized. Furthermore, the oxidizing agent is selected from a group consisting of oxygen, nitrous oxide, carbon dioxide, ozone and a combination thereof. The temperature in the thermal oxidation process is closely related to thickness of the low-k dielectric material layer 102. In general, the thicker the low-k dielectric material layer 102, the higher will be the required temperature. The temperature in the thermal oxidation process is, for example, between about 200° C. to 1500° C. The plasma oxidation process can be carried out inside a stripping machine or etching machine. The reactive gases passed into the machine are selected from a group consisting of oxygen, carbon dioxide, nitrous oxide and a combination thereof. The reactive gases used in the dry etching process are oxygen and fluorine-containing gases such as carbon tetrafluoride and/or nitrogen trifluoride and the carrier gas is nitrogen or argon, for example. During the reaction, the reactive gases flow into the reaction chamber at a constant rate or are suitably varied and adjusted according to the actual requirements.

As shown in FIGS. 1C and 2, a wet etching process is performed in step 208 to remove the residual low-k dielectric constant material layer 102. The etchant used in the wet etching process includes hydrofluoric acid. Because the hard-to-remove by acid component or impurity inside the low-k dielectric constant material layer 102 has already been removed, the residual low-k dielectric constant material layer 102 is easily removed by performing the wet etching process.

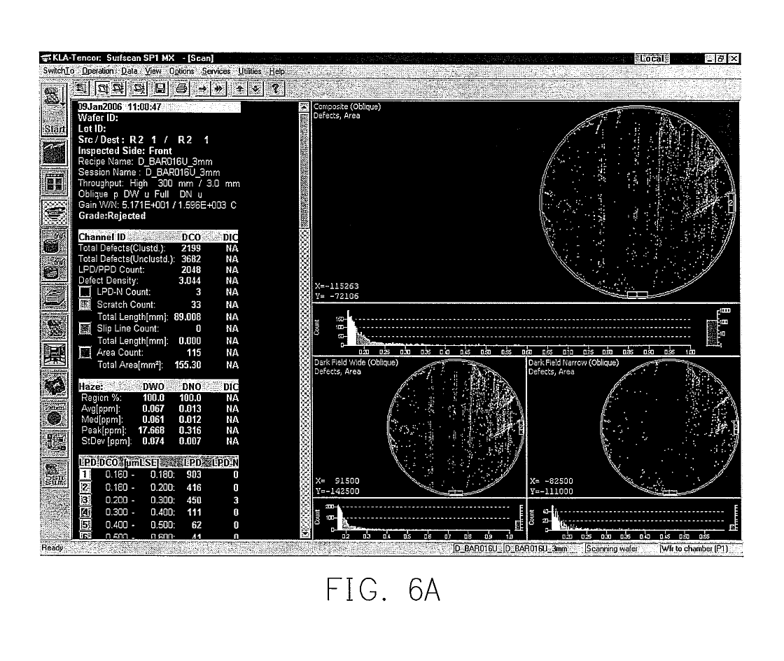

As shown in FIG. 4, when the low-k dielectric constant material layer 102 deposited on the dummy wafer 10 covers not only the front surface of the substrate 100 but also the bevel area at the back of the substrate 100, the low-k dielectric constant material layer 102 on the bevel area at the back of the substrate 100 must also be removed before the dummy wafer 10 can be recycled. If the low-k dielectric constant material layer 102 is a carbon-containing material such as SiC, SiCN, SiCO, SiCOH, SiCNO or is a porous material capable of adsorbing carbon impurities 104, the low-k dielectric constant material layer 102 is difficult to remove using hydrofluoric acid as the etchant. To effectively remove the low-k dielectric constant material layer 102 on the front as well as on the bevel area at the back of the substrate 100, the foregoing method can be used. However, in the beginning or during the treatment process 106, the substrate 100 is pined up via the back of the substrate 100 so that the low-k dielectric constant material layer 102 covering the bevel area at the back of the substrate 100 is exposed. Hence, the component or impurities 104 inside the low-k dielectric constant material layer 102 covering the bevel area at the back of the substrate 100 also contact the reactive gases to initiate oxidation and/or nitridation, thereby forming volatile substances 108. Afterwards, a wet etching process is performed to remove the residual low-k dielectric constant material layer 102 on both the front and the back surface of the substrate 200. In one embodiment, the process treatment 106 is a plasma oxidation process or a dry etching process. Then, a lift pin 110 in the chamber underneath the substrate 100 can be used to pin up the substrate 100. In addition, during the reaction, the reactive gases flow into the reaction chamber at a constant rate or are suitably varied and adjusted according to the actual requirements. For example, if the treatment process 106 is a dry etching process, oxygen and carbon tetrafluoride are passed into the reaction chamber so that the low-k dielectric constant material layer 102 on the front surface of the substrate 200 reacts. Then, the lift pin 110 is raised to push up the substrate 200 and the reactive gas is changed to oxygen so that the low-k dielectric constant material layer 102 at the back of the substrate 200 also reacts. Finally, hydrofluoric acid solution is used to remove the low-k dielectric constant material layer 102.

### FIRST EXAMPLE

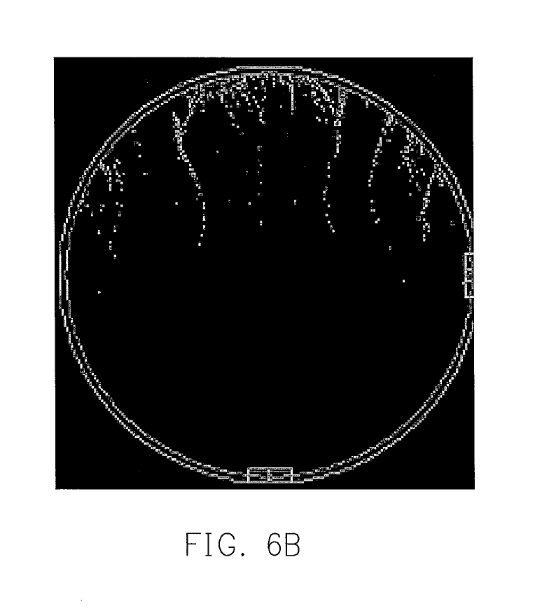

A high temperature oxidation process at two different temperatures is performed to dummy wafers having a low-k dielectric constant material layer of different thickness thereon. The results are listed in table 1. According to the result in table 1, when an oxidation process is performed at 250° C. to a thinner (900 Å) low-k dielectric constant material layer and then treated using hydrofluoric acid, the film thickness can be reduced to below 16 Å within the error range of measurement. Therefore, the dummy wafers meet the recycle standard. When an oxidation process is performed at 800° C. to a thicker (4800 Å) low-k dielectric constant material layer and then treated using hydrofluoric acid, the film thickness can be reduced to below 6 Å within the error range of measurement. Therefore, the dummy wafers meet the recycle standard. A photo of the dummy wafers is shown in FIG. 5.

TABLE 1

| | | Before High Temp | | After High Temp | | After | |
|---|---|---|---|---|---|---|---|
| | | Oxidation | | Oxidation | | HF Etching | |
| | High Temp | Film | | Film | | Film | |
| | Oxidation | Thickness | Refractive | Thickness | Refractive | Thickness | |
| No. | Conditions | (Å) | Index | (Å) | Index | (Å) | GOF |
| 1 | O₂/250° C. | 907 | 1.4686 | 830 | 1.4833 | 15 | 0.99 |
| 2 | O₂/250° C. | 927 | 1.4686 | 849 | 1.4818 | 16 | 0.99 |
| 3 | O₂/250° C. | 1505 | 1.4743 | 1431 | 1.4805 | 36 | 0.99 |
| 4 | O₂/250° C. | 1502 | 1.4737 | 1430 | 1.4796 | 35 | 0.99 |
| 5 | O₂/250° C. | 4823 | 1.4578 | 4738 | 1.4612 | 291 | 0.11 |
| 6 | O₂/250° C. | 4731 | 1.4562 | 4649 | 1.4595 | 280 | 0.06 |
| 7 | O₂/800° C. | 4782 | 1.4581 | 4305 | 1.4718 | 6 | 0.99 |
| 8 | O₂/800° C. | 4772 | 1.4592 | 4296 | 1.4691 | 6 | 0.99 |
| 9 | O₂/800° C. | 4789 | 1.4563 | 4312 | 1.4725 | 6 | 0.99 |
| 10 | O₂/800° C. | 4763 | 1.4580 | 4290 | 1.4716 | 6 | 0.99 |

GOF: Good of fitness

### SECOND EXAMPLE

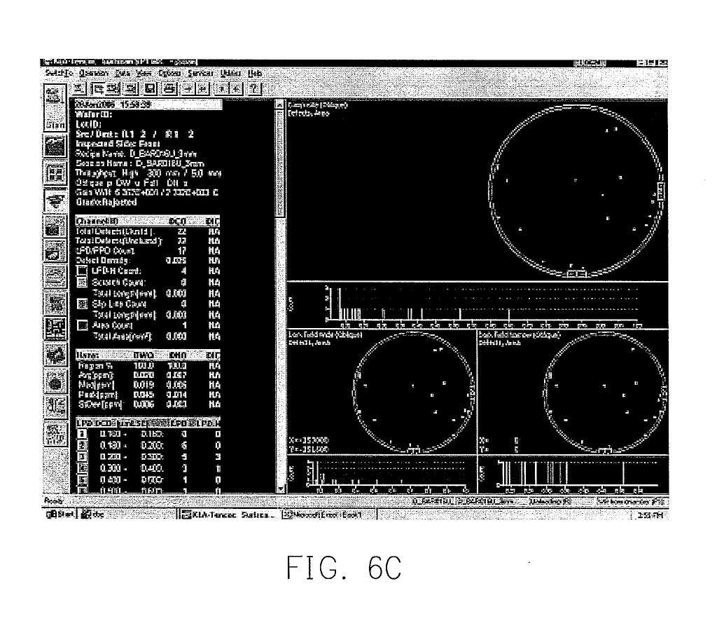

The results of using the process in table 2 to treat the low-k dielectric constant material layer on the front and back surface of dummy wafers are shown in FIGS. 6A through 6C. As shown in FIG. 6A, residues are left if the dummy wafer is directly treated using hydrofluoric (HF) acid. As shown in FIG. 6B, the amount of residues left are significantly reduced after using reactive gases CF₄ and O₂ to perform an etching process followed by performing an etching process with hydrofluoric acid. As shown in FIG. 6C, after pin up the dummy wafer with the lift pin, performing an etching process using reactive gases CF₄ and O₂ and then with hydrofluoric acid, the low-k dielectric constant material layers on the front and back of the dummy wafer are removed. Ultimately, the dummy wafer is able to meet the recycle standard.

TABLE 2

| | Dry Etching | | |
|---|---|---|---|
| | Pin up dummy | Reactive Gases | Wet Etching |
| No. | wafer with lift pin | CF₄ + O₂ | Hydrofluoric Acid Etching |
| 1 | — | — | √ |
| 2 | — | √ | √ |
| 3 | √ | √ | √ |

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of recycling dummy wafer, wherein the dummy wafer comprises a substrate with at least a low-k dielectric constant material layer thereon, and the low-k dielectric constant material layer contains a component or adsorbed impurities, comprising:
performing a treatment process to convert the component or the impurities into a volatile substance; and
performing a wet etching process to remove the low-k dielectric constant material layer.

2. The recycling method of claim 1, wherein the component or the impurities comprises carbon.

3. The recycling method of claim 1, wherein the material constituting the low-k dielectric constant material comprises SiC, SiCN, SiCO, SiCOH, SiCNO or porous material.

4. The recycling method of claim 1, wherein the treatment process comprises an oxidation process and/or a fluorination process.

5. The recycling method of claim 4, wherein the treatment process comprises a thermal oxidation process, a plasma oxidation process or a dry etching process.

6. The recycling method of claim 5, wherein thermal oxidation process uses an oxidizing agent selected from a group consisting of oxygen, nitrous oxide, carbon dioxide, ozone and a combination thereof.

7. The recycling method of claim 6, wherein the thermal oxidation process is carried out at a temperature between about 200° C. to 1500° C.

8. The recycling method of claim 5, wherein the plasma oxidation process uses a gas selected from a group consisting of oxygen, carbon dioxide, nitrous oxide and a combination thereof.

9. The recycling method of claim 5, wherein the dry etching process uses a fluorine-containing gas and oxygen.

10. The recycling method of claim 9, wherein the fluorine-containing gas comprises carbon tetrafluoride and/or nitrogen trifluoride.

11. The recycling method of claim 5, wherein, in the beginning and during the plasma oxidation process and the dry etching process, further comprises exposing a bevel area at the back of the substrate so that the low-k dielectric constant material layer on the bevel area at the back of the substrate is also removed.

12. The recycling method of claim 11, wherein the method of exposing the bevel area at the back of the dummy wafer comprises pining up the dummy wafer via the back of the substrate.

13. The recycling method of claim 1, wherein an etchant used in the wet etching process comprises hydrofluoric acid.

14. The recycling method of claim 1, wherein the low-k dielectric constant material layer comprises a dielectric layer and/or a barrier layer.

15. A method of removing a low-k dielectric constant material layer covering a bevel area at the back of a substrate, wherein the low-k dielectric constant material layer contains a component or adsorbed impurities, comprising:
pining up the substrate via the back of the substrate so that the low-k dielectric constant material layer covering the bevel area at the back of the substrate is exposed;
performing a treatment process so that the component or the impurities is converted into a volatile substance; and
performing a wet etching process to remove the low-k dielectric constant material layer.

16. The method of claim 15, wherein the component or the impurities comprises carbon.

17. The method of claim 15, wherein the material constituting the low-k dielectric constant material comprises SiC, SiCN, SiCO, SiCOH, SiCNO or porous material.

18. The method of claim 15, wherein the treatment process comprises an oxidation process and/or a fluorination process.

19. The method of claim 18, wherein the treatment process comprises a plasma oxidation process or a dry etching process.

20. The method of claim 19, wherein the plasma oxidation process uses a gas selected from a group consisting of oxygen, carbon dioxide, nitrous oxide and combination thereof.

21. The method of claim 19, wherein the dry etching process uses a fluorine-containing gas and oxygen.

22. The method of claim 21, wherein the fluorine-containing gas comprises carbon tetrafluoride and/or nitrogen trifluoride.

23. The method of claim 15, wherein an etchant used in the wet etching process comprises hydrofluoric acid.

24. The method of claim 15, wherein the low-k dielectric constant material layer comprises a dielectric layer and/or a barrier layer.
